(19) United States
(12) Patent Application Publication
(10) Pub. No.: US 2006/0280044 A1
(43) Pub. Date: Dec. 14, 2006

(54) Recording head for magneto-optical recording device and magneto-optical recording device comprising the same

(75) Inventors: Hans Willem Van Kesteren, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,623

(22) PCT Filed: Sep. 3, 2004
(86) PCT No.: PCT/IB04/51680

§ 371 Date: Mar. 14, 2006

(30) Foreign Application Priority Data
Sep. 22, 2003 (EP) 03103494.5

(51) Int. Cl. G11B 11/00

(52) U.S. Cl. 369/13.17

(57) ABSTRACT

A recording head for magneto-optical recording in a first-surface recording configuration comprises a transparent aperture (8;22;32), in a plane intended to be substantially parallel to a recordable medium (2), in use. The head is arranged to provide an optical path allowing a bundle of light (6) to pass through the transparent aperture (8;22;32) onto the recordable medium (2), and further comprises a central magnetic head structure (11;20;34) comprising a flux guide (12;24;35), positioned so as to partially obstruct the transparent aperture (8;22;32). The central magnetic head structure (11;20;34) is of a substantially larger dimension in a first direction (x) parallel to the plane than in a second direction (y) parallel to the plane.

The invention relates to a recording head for magneto-optical recording in a first-surface recording configuration, comprising

a transparent aperture, in a plane intended to be substantially parallel to a recordable medium, in use,

the head being arranged to provide an optical path allowing a bundle of light to pass through the transparent aperture onto the recordable medium, and further comprising

a central magnetic head structure comprising a flux guide, positioned so as to partially obstruct the transparent aperture.

The invention further relates to a magneto-optical recording device comprising such a recording head.

An example of a recording head and device of the types mentioned above is known from WO 00/31734. The known head is part of a system comprising a magnetic head, an optical sub-system with a radiation source for generating a beam of radiation, a recordable medium suitable for recording or erasing information therein or thereon under combined control of the magnetic head and radiation source. Head and source are positioned on the same side of the recordable medium. The system further comprises a reflective medium to reflect the radiation incident on it from the source onto the recordable medium. The magnetic head is located in the optical path between radiation source and recordable medium so as to obstruct the beam only partly. The reflective medium serves to create a focal point of the optical system at a location in the recordable medium.

A problem of the known configuration is that the recording layer is situated in between the recording head and the reflective medium and the light has to pass through the layer during recording. As this layer is generally metallic, its transmission coefficient is low. This is especially problematic when the recorded data is also read out by means of a light beam passing through the recording head, as is the case for magneto-optical recording using the Kerr effect, for example. The reflective medium is necessary in order to apply sufficient light energy to a spot in the recording layer of the recordable medium.

It is an object of the invention to provide a recording head and recording device of the types mentioned above, which provide both a magnetic field and a light beam of sufficient strength and intensity, respectively, on the recordable medium, while enabling the magnetic field and light beam to be generated with relatively little power.

This object is achieved by the recording head according to the invention, which is characterized in that the central magnetic head structure is of a substantially larger dimension in a first direction parallel to the plane than in a second direction parallel to the plane.

The invention is based on the recognition that, in order to obtain a relatively high magnetic field strength for a given field-generating current, the central magnetic head structure, and in particular the flux guide part, should have a large cross-sectional area. On the other hand, obscuring part of the spot generated by the beam of light will lead to a sharpening of the spot profile and the occurrence of side lobes. Side lobe intensities can be kept small when the obscuration is small, so that it is advantageous to keep them small in one direction to prevent thermal heating by the side lobes and thus broadening of the thermal profile, which could otherwise corrupt adjacent bits recorded on the medium.

In a preferred embodiment, the central magnetic head structure comprises at least one electrically conductive winding.

Thus the magnetic field used for recording is at least partly generated by passing a current through these windings. Because they are in the central magnetic head structure, they can have a small diameter, thus resulting in a coil with a relatively low self-inductance. This has the advantage of making the recording head more suitable for high bit-rate recording and generally all recording techniques requiring frequent reversal of the direction of the magnetic field, for example laser-pulsed magnetic field modulation.

In a preferred embodiment, the flux guide comprises a central pole having an axis substantially centred on the bundle of light passing through the transparent aperture.

Thus, the magnetic flux is concentrated in a small area around the spot in the recordable medium on which the bundle of light is focussed. This allows a highly efficient magnetic head, which can be operated from a low power driver.

In an embodiment combining the two previously described embodiments, at least one winding is wound around the central pole.

Thus, the highest possible magnetic head efficiency at the lowest self-inductance is achieved, since the magnetic field is generated only in a small area around the optical spot and the compact size of the magnetic head and its windings lead to a relatively low self-inductance.

Preferably, the recording head comprises at least one return pole, having an axis parallel to the axis of the central pole.

Thus, the flux in the recordable medium is concentrated, since the flux lines will be concentrated on a path from the central pole to the return pole, rather than spreading out through the recordable medium. This increases the effectiveness of the recording head.

An advantageous embodiment further comprises an annular outer magnetic head structure, surrounding the central magnetic head structure and having an inner diameter exceeding the diameter of a bundle of light passing through the aperture.

The annular outer magnetic head structure preferably comprises a coil for enhancing the magnetic field created by the central magnetic head structure, but may comprise only a yoke for concentrating the flux generated by the latter. Thus, the magnetic field strength created is enhanced. The annular magnetic head structure does not obstruct the bundle of light, so its dimensions are less critical. Without the annular outer magnetic head structure, the magnetic field strength would be constrained by the dimensions of the central magnetic head structure, which may not obscure the beam of light too much. Furthermore, due to its compactness, the central magnetic head structure comprising electrically conductive windings may, when used on its own, heat up, so reducing the efficiency. Because at least part of the magnetic field is generated by the central magnetic head structure, with its windings of small diameter, the recording head allows faster switching than a recording head comprising only the annular outer magnetic head structure.

Preferably, the recording head comprises a catadioptric optical system, arranged to provide the optical path.

This has the advantage that, in a split-optics configuration, in which the optics for reading data are separated from those for recording, the optical spot and magnetic recording field are kept well aligned upon small variations in the angle of the bundle of light entering the optical system. Furthermore, the recording head remains relatively compact. In particular, the mass of the recording head can thus be kept low. This is of importance for both recording heads comprising a slider and those that are actuated in order to keep the beam of light focussed to a spot in the recording layer of the recordable medium.

Preferably, the catadioptric optical system is arranged to transform an incoming bundle of light into a hollow bundle of light.

In this respect, a hollow beam of light is to be taken to mean a beam of light of which the intensity profile taken over the cross-sectional area is much lower in the center than elsewhere. This embodiment has the advantage that the central magnetic head structure can be placed in the center of the hollow beam of light, thus avoiding loss of light power through absorption in and reflection off the central magnetic head structure.

In a further embodiment, the central magnetic head structure extends beyond an outer dimension of the aperture in the first direction.

Thus, it is possible to channel externally generated magnetic flux into the central magnetic head structure.

According to another aspect of the invention, the magneto-optical recording device according to the invention comprises a recording head according to the invention.

The invention will now be explained, by way of example, in further detail with reference to the accompanying drawings, in which:

FIG. 1 shows schematically, and not to scale, a cross-section of a first configuration for a recording head;

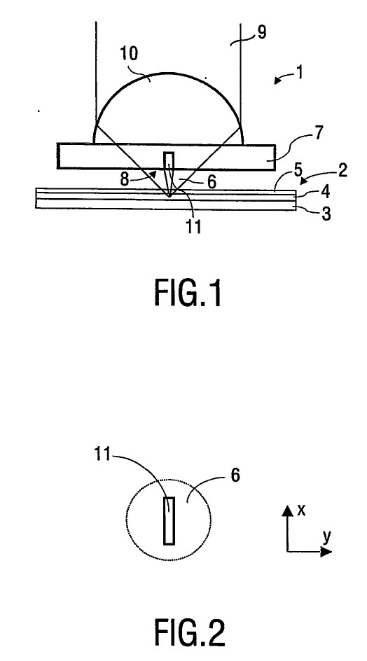

FIG. 2 is a bottom view of the aperture of the recording head of FIG. 1;

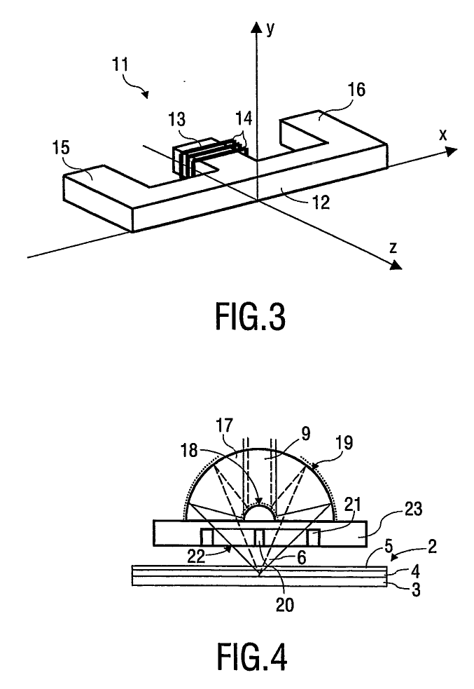

FIG. 3 is a schematic perspective view of the magnetic head structure of FIG. 1;

FIG. 4 shows schematically, and not to scale, a cross-section of a recording head with a catadioptric focussing system and a central as well as an outer magnetic head structure;

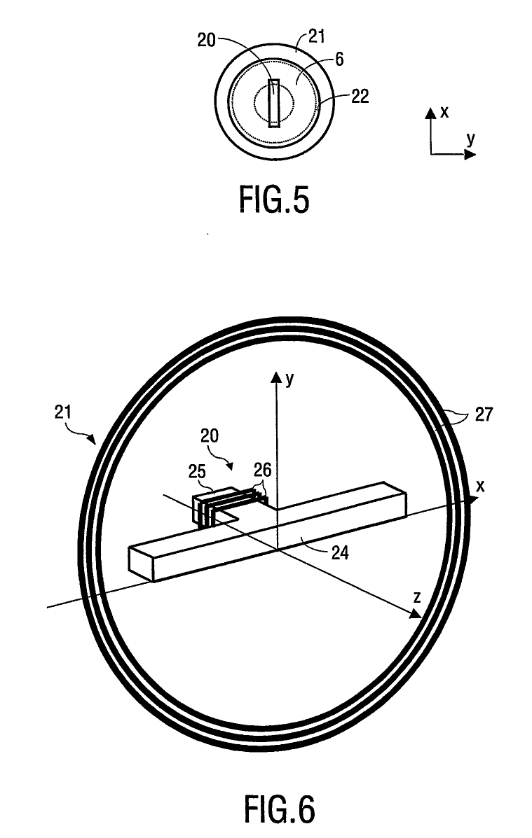

FIG. 5 is a bottom view of the aperture of the recording head of FIG. 4;

FIG. 6 is a schematic perspective view of the central and outer magnetic head structures of FIG. 4;

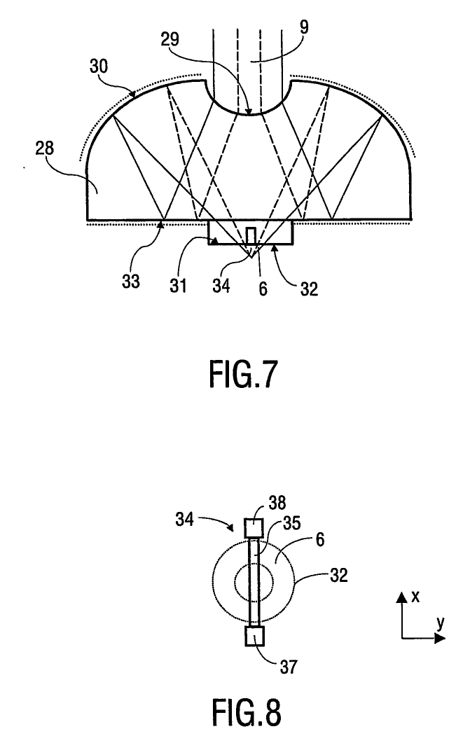

FIG. 7 shows schematically, and not to scale, a cross-section of a second type of recording head with a catadioptric focussing system, comprising merged central and outer magnetic head structures;

FIG. 8 is a bottom view of the aperture of the recording head of FIG. 7; and

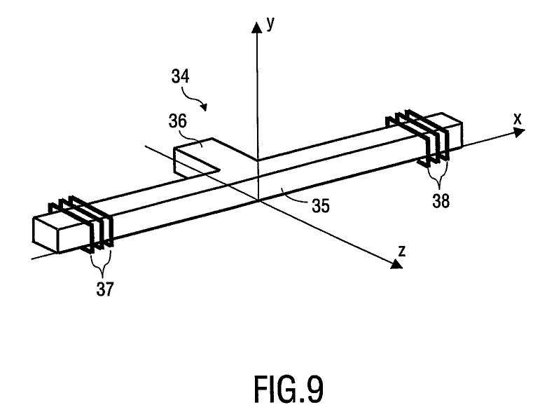

FIG. 9 is a schematic perspective view of the merged central and outer magnetic head structures in the recording head of FIG. 7.

A recording head 1, as shown in FIG. 1, is provided for magneto-optical recording of information onto a recordable medium 2. The recordable medium 2 is shown only very schematically, with only a substrate 3, a thin-film recording stack 4 and a cover layer 5 being indicated. It is to be understood that a real recordable medium will comprise more layers, in particular the thin-film recording stack 4 will comprise many more layers, differing in composition. Information is recorded by focussing a bundle of light 6 onto a spot in the thin-film recording stack 4 and applying a magnetic field in a specific direction, in accordance with the information to be written. Because the light is incident on the thin-film recording stack 4 without passing the substrate 3, this recording configuration is referred to as first-surface recording. Simply put, except for the (optional) thin cover layer 5, the layer comprising the recording stack 4 is the first layer encountered by the incident light.

The recording head 1 comprises a glass substrate 7, with an aperture 8 for allowing light to pass onto the recordable medium 2. The outer diameter of the aperture 8 is larger than the outer diameter of the bundle of light passing through it, so as not to diminish the amount of light transmitted. The outer diameter of the bundle of light 6 that passes through the aperture 8 is determined by the diameter of an incoming bundle of light 9 and the optical system comprised in the recording head 1 for transforming the incoming bundle of light 9 into the bundle of light 6 focussed on a recording spot in the recordable medium 2. Thus, the recording head 1 is arranged to provide an optical path, allowing a bundle of light 6 to pass through the aperture 8. In the example of FIG. 1, the optical system is formed principally by a lens 10.

In the configuration of FIG. 1, the magnetic field is generated by means of a central magnetic head structure 11. The inner part of the bundle of light 6 is obscured by the central magnetic head structure 11.

It will be apparent from FIG. 2 that the inner aperture 8 has an outer diameter large enough to allow the hollow bundle of light 6, formed from the incoming bundle of light 9 to pass through substantially unobstructed at its perimeter. By contrast, the central magnetic head structure 11 is positioned in the optical path along which the hollow bundle of light 6 is transmitted, so as to partially obstruct the transparent aperture 8 from the center outwards.

It can be seen that the central magnetic head structure 11 is of a substantially larger dimension (i.e. an order of magnitude higher than the usual manufacturing tolerances) in a first direction, marked as the x-direction in FIGS. 2 and 3, than in a second direction perpendicular thereto, marked as the y-direction in FIGS. 2 and 3. The central magnetic head structure 11 is thus rotationally asymmetric. Note that in the reference system of FIGS. 2 and 3, the x- and y-axis are substantially parallel to the plane in which the aperture 8 lies, which in turn is substantially parallel to the recordable medium 2, in use. It is further observed that the cross-section perpendicular to the direction in which light is emitted from the recording head 1 can be any other rotationally asymmetric shape, i.e. elliptical, star-shaped, crescent-shaped, etc. The rectangular shape is just an example.

FIG. 3 shows an advantageous embodiment of the central magnetic head structure 11. It comprises an E-shaped yoke 12 of soft magnetic material, acting as a flux guide. The yoke 12 is processed using hard-disk like thin-film technologies. Its processing plane is in principle perpendicular to the y-direction, although it may also be perpendicular to the z-direction. Suitable materials include NiFe and CoZrNb. The yoke 12 comprises a central pole 13, aligned along the z-axis. In use, the central pole 13 is substantially centered on the bundle of light 6 passing through the aperture 8 (cf FIG. 2). The optical system is arranged to focus the bundle of light 6 onto a spot lying substantially on the continuation of a longitudinal axis of the central pole 13. Thus, the magnetic field is concentrated on the spot on which the bundle of light 6 is focussed.

A number of turns 14 of electrically conductive material form a winding around the central pole 13. The winding is preferably also formed using thin-film technology. Although the winding may be made of metal, in an advantageous embodiment, at least some of the turns 14 are made of a transparent material, such as Indium Tin Oxide (ITO). In particular, inner turns immediately adjacent the central pole 13 may be of metal, whereas outer turns at a distance from the central pole are made of ITO. Such a combination has the advantage that the outer turns do not obstruct the bundle of light, thereby increasing the amount of light that can be focussed on the recording spot, whereas the inner turns have a lower resistance, thus increasing the field generation efficiency and decreasing the amount of heat dissipated in the winding.

The other legs of the E-shaped yoke 12 are formed by return poles 15,16, which serve to obtain a good magnetic efficiency. It is observed that this depends partially on the distance between the central pole 13 and the outer return poles 15,16. The E-shaped yoke 12 allows an optimum distance to be determined using known methods of magnetic field calculation in a relatively straightforward manner.

It is observed that the partial obscuration of the bundle of light near the aperture leads to the sharpening of the light intensity profile in this direction (i.e. the x-direction in the example). However, side-lobes also arise. This effect is less marked in the other direction, i.e. the y-direction in the example. It is possible to arrange the recording device comprising the recording head 1 in such a manner that the recording tracks are in the y-direction. Alternatively, they may be in the x-direction.

Whichever configuration is chosen, it is important that the recording magnetic field area on the disk stays aligned with the spot on which the bundle of light 6 is focussed. A way of doing this in a split optics configuration, i.e. where the laser and detection optics (not shown) are mechanically separated from the recording head 1, is to use a light path where the bundle of light is fixed with respect to the focussing lens 10. An example is a sliding head with integrated lens and a fibre fixed to the slider for coupling the light into the lens. The preferred way, shown in FIGS. 4 and 7 in two exemplary embodiments, is by means of a catadioptric optical system. A catadioptric system has the advantage that, when the stop is on the exit surface of the lens, the magnetic field and focussed spot stay in better alignment upon variations in the angle of the incoming bundle of light 9 than in a conventional focussing system, because of the small free working distance (distance to the recordable medium 2). Furthermore, catadioptric lenses have the advantage of being relatively compact. In addition, they allow, in the shown embodiments, a relatively high numerical aperture, as well as the aforementioned relatively small free working distance. The relatively high numerical aperture allows more light to be focussed on the recording spot for a given cross-sectional area of the aperture 8. The small free working distance allows stronger magnetic fields to be achieved at the area of recording on the recordable medium 2 for a given current through the winding(s).

In FIG. 4, the optical system comprises a catadioptric focussing lens 17. The optical system transforms the incoming bundle of light 9 into the hollow bundle of light 6. This is due to the fact that the focussing lens comprises a convex surface part 18, on a side opposite the side of the focussing lens 17 at which the incoming bundle of light 9 enters the focussing lens 17. The convex surface part 18 is covered by a reflective coating, indicated by means of a dotted line. An annular part 19 of the opposite surface of the focussing lens 17 is also covered by a coating that is reflective at the wavelengths present in the incoming bundle of light 9. Thus, light is reflected off the convex surface part 18, onto the annular part 19 and then passes through the remaining surface part adjacent the aperture 22, to be focussed on the recording spot. The edges of the incoming and transformed bundle of light 9,6 are shown, in order to demonstrate that the incoming bundle of light 9 is transformed into the hollow bundle of light 6, which substantially circumvents a central magnetic head structure 20.

In the configuration of FIG. 4, the magnetic field is generated by means of a central magnetic head structure 20, of which the operation is enhanced by means of an annular outer magnetic head structure 21. The annular outer magnetic head structure 21 serves to increase the magnetic flux generated by the central head structure 20 at the recording spot on the recordable medium 2.

It will be apparent from FIG. 5 that the inner diameter of the outer magnetic head structure 21 is large enough to allow the hollow bundle of light 6, formed from the incoming bundle of light 9, to pass through substantially unobstructed at its perimeter. In contrast, the central magnetic head structure 20 is positioned in the optical path along which the hollow bundle of light 6 is transmitted, so as to partially obstruct a transparent aperture 22 in a glass substrate 23 similar to those of the embodiment shown in FIG. 1. In fact, in the example of FIG. 4, some of the hollow bundle of light 6 actually impinges on the central magnetic head structure 20. In general, however, this need not be the case. That is to say the hollow bundle of light could have an inner diameter large enough to prevent any light from falling onto the central magnetic head structure 20.

FIG. 6 shows an advantageous embodiment of the central magnetic head structure 20. It comprises a T-shaped yoke 24 made of soft magnetic material, acting as a flux guide. In use, a central pole 25 is substantially centered on the (hollow) bundle of light 6 passing through the aperture (cf. FIG. 4). The optical system is arranged to focus the bundle of light 6 on a spot lying substantially on the continuation of a longitudinal axis of the central pole 25. Thus, the magnetic field is concentrated on the spot on which the bundle of light 6 is focused.

A number of turns 26 of electrically conductive material form a winding around the central pole 25. The T-shaped yoke 24 is combined with an annular outer magnetic head structure 21, comprising a plurality of turns 27 of a circular winding. By applying a current through these windings, the field in the center can be further enhanced.

In the embodiment of FIG. 7, another type of catadioptric focussing system is used. The embodiment of FIG. 7 also comprises a focussing lens 28. A central area 29 of the entrance surface is concave. A peripheral area 30 is convex and coated with a reflective coating. A central part 31 of the exit surface adjacent to an aperture 32 in a substrate is co-planar with the aperture 32 and has a high transmittance. A peripheral part 33 of the exit surface is coated with a reflective coating. The concave central area 29 spreads the incoming beam of light, of which a substantial part is reflected by the peripheral part 33 of the exit surface and subsequently by the peripheral area 30 of the entrance surface, thus creating a hollow beam focussed through the central part 31 of the exit surface and the aperture 32.

In FIG. 8, an alternative central magnetic head structure 34 is shown that fully obscures the outgoing bundle of light 6 in the x-direction.

FIG. 9 shows the central magnetic head structure 34 in more detail. It comprises a T-shaped yoke 35 of soft magnetic material, acting as a flux guide. In use, a central pole 36 is substantially centered on the (hollow) bundle of light 6 passing through the aperture 32 (cf. FIG. 7). The optical system is arranged to focus the bundle of light 6 on a spot lying substantially on the continuation of a longitudinal axis of the central pole 36. Thus, the magnetic field is concentrated on the spot on which the bundle of light 6 is focussed.

A number of turns of electrically conductive material form the windings of two coils 37,38, one around each outer leg of the T-shaped yoke 35. Because the windings are situated outside the bundle of light 6, the dimensions of the coils 37,38 and the number of turns are not limited by optical requirements. Flux generated by the outer coils is transported through the T-shaped flux guide to the central pole 36 and concentrated on the recording area.

The catadioptric embodiments have the advantage that they are relatively easy to manufacture within narrow tolerance ranges. This is due to the use of coated focussing lenses 17,28 of which the surface can be polished to the required shape.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage. For instance, the annular outer magnetic head structure may provide the return poles for completing a magnetic circuit, which also includes the central pole of the central magnetic head structure.

1. Recording head for magneto-optical recording in a first-surface recording configuration, comprising a transparent aperture (8;22;32), in a plane intended to be substantially parallel to a recordable medium (2), in use, the head being arranged to provide an optical path allowing a bundle of light (6) to pass through the transparent aperture (8;22;32) onto the recordable medium (2), and further comprising
a central magnetic head structure (11;20;34) comprising a flux guide (12;24;35), positioned so as to partially obstruct the transparent aperture (8;22;32), wherein the central magnetic head structure (11;20;34) is of a substantially larger dimension in a first direction (x) parallel to the plane than in a second direction (y) parallel to the plane.

2. Recording head according to claim 1, wherein the central magnetic head structure (11;20;34) comprises at least one electrically conductive winding.

3. Recording head according to claim 2, wherein at least some turns (14) of a winding are made of a transparent material.

4. Recording head according to claim 1, wherein the flux guide (12;24;35) comprises a central pole (13;25;36) having an axis substantially centered on the bundle of light (6) passing through the transparent aperture (8;22;32).

5. Recording head according to claim 2, wherein at least one winding is wound around the central pole (13).

6. Recording head according to claim 4, comprising at least one return pole (15,16), having an axis parallel to the axis of the central pole (13).

7. Recording head according to claim 1, wherein the flux guide (12) comprises an E-shaped yoke.

8. Recording head according to claim 1, further comprising an annular outer magnetic head structure (21), surrounding the central magnetic head structure (20) and having an inner diameter exceeding the diameter of a bundle of light (6) passing through the aperture (22).

9. Recording head according to claim 1, comprising a catadioptric optical system, arranged to provide the optical path.

10. Recording head according to claim 9, wherein the catadioptric optical system is arranged to transform an incoming bundle of light (9) into a hollow bundle of light (6).

11. Recording head according to claim 1, wherein the central magnetic head structure (34) extends beyond an outer dimension of the aperture (32) in the first direction (x).

12. Recording head according to claim 2, wherein at least one winding (37;38) is wound around a part of the flux guide (35) positioned outside a perimeter of the aperture (32).

13. Magneto-optical recording device, comprising the recording head according to claim 1.
